(19) United States
(12) Patent Application Publication
(10) Pub. No.: US 2023/0222324 A1
(43) Pub. Date: Jul. 13, 2023

(54) LEARNING METHOD, LEARNING APPARATUS AND PROGRAM

(71) Applicant: NIPPON TELEGRAPH AND TELEPHONE CORPORATION, Tokyo (JP)

(72) Inventor: Tomoharu IWATA, Tokyo (JP)

(73) Assignee: NIPPON TELEGRAPH AND TELEPHONE CORPORATION, Tokyo (JP)

(21) Appl. No.: 18/007,703

(22) PCT Filed: Jun. 8, 2020
(86) PCT No.: PCT/JP2020/022566

§ 371 Date: Dec. 1, 2022

(51) Int. Cl. G06N 3/045; G06N 3/08

(52) U.S. Cl. CPC G06N 3/045; G06N 3/08

(57) ABSTRACT

A method includes receiving data including cases and labels therefor, calculating a predicted value of a label for each case included in the data using parameters of a neural network and information representing cases in which the labels are observed among the cases in the data, selecting one case from the data using parameters of another neural network and information representing the cases where the labels are observed among the cases in the data, training the parameters of the neural network using an error between the predicted value and a value of the label for each case in the data, and training the parameters of the other neural network using the error and another error between a predicted value of a label for each case when the one case is additionally observed and a value of the label for the case.

### TECHNICAL FIELD

The present invention relates to a learning method, a learning apparatus, and a program.

### BACKGROUND ART

In general, in machine learning methods, higher performance can be achieved with a larger number of labeled learning cases. On the other hand, there is a problem that it is expensive to label a large number of learning cases.

In order to solve this problem, an active learning method of labeling cases with uncertain predictions has been proposed (for example, NPL 1).

### CITATION LIST

### Non Patent Literature

[NPL 1] Lewis, David D and Gale, William A, “A sequential algorithm for training text classiers”. Proceedings of the 17th Annual International ACM SIGIR Conference on Research and Development in Information Retrieval, pp. 3-12, 1994.

### SUMMARY OF THE INVENTION

### Technical Problem

However, since selection of a case for directly increasing the machine learning performance is not performed in the existing active learning method, there is a problem that sufficient performance cannot be achieved.

In view of the aforementioned circumstance, an object of one embodiment of the present invention is to train a case selection model and a label prediction model to obtain a high-performance case selection model and a high-performance label prediction model.

### Means for Solving the Problem

To accomplish the above object, a learning method according to one embodiment executes, by a computer, an input procedure for receiving data G_{d} including cases and labels for the cases, a prediction procedure for calculating a predicted value of a label for each case included in the data G_{d} using parameters of a first neural network and information representing cases in which the labels are observed among the respective cases included in the data G_{d}, a selection procedure for selecting one case from the respective cases included in the data G_{d} using parameters of a second neural network and information representing the cases in which the labels are observed among the respective cases included in the data G_{d}, a first learning procedure for training the parameters of the first neural network using a first error between the predicted value and the value of the label for each case included in the data G_{d}, and a second learning procedure for training the parameters of the second neural network using the first error and a second error between a predicted value of a label for each case when the one case is additionally observed and the value of the label for each case.

### Effects of the Invention

It is possible to train a case selection model and a label prediction model to obtain a high-performance case selection model and a high-performance label prediction model.

### BRIEF DESCRIPTION OF DRAWINGS

FIG. 1 is a diagram showing an example of a functional configuration of a learning apparatus according to the present embodiment.

FIG. 2 is a flowchart showing an example of a flow of a training process according to the present embodiment.

FIG. 3 is a flowchart showing an example of a flow of a prediction model training process according to the present embodiment.

FIG. 4 is a flowchart showing an example of a flow of a selection model training process according to the present embodiment.

FIG. 5 is a diagram showing an example of evaluation results.

FIG. 6 is a diagram showing an example of a hardware configuration of the learning apparatus according to the present embodiment.

### DESCRIPTION OF EMBODIMENTS

Hereinafter, one embodiment of the present invention will be described. In the present embodiment, a learning apparatus 10 for training a case selection model (hereinafter referred to as a “selection model”) for selecting a case to be labeled and a label prediction model (hereinafter referred to as a “prediction model”) for predicting a label for a case when a plurality of data sets including cases and labels thereof are provided will be described.

It is assumed that the learning apparatus 10 according to the present embodiment is provided with a graph data set composed of D pieces of graph data, represented by the following formula, as input data at the time of learning.

[symbol]

={G_{d}}_{d=1}^{D} [Math. 1]

In the text of the description, this graph data set is denoted by “G”.

Here, G_{d}=(A_{d}, X_{d}, y_{d}) is graph data representing a d-th graph. In this regard,

A_{d}∈{0,1}^{N}^{_{d}}^{×N}^{_{d}} [Math. 2]

represents an adjacency matrix of the d-th graph, wherein N_{d} is the number of nodes in the d-th graph. In addition,

X_{d}=(x_{dn})ₙ₌₁^{N}^{_{d}}∈ [symbol] ^{N}^{_{d}}^{×J}^{_{d}} [Math. 3]

represents feature data of the d-th graph.

x_{dn}∈ [symbol] ^{J}^{_{d}} [Math. 4]

represents a feature of an n-th node in the d-th graph, wherein J_{d} is the number of dimensions of the feature of the d-th graph. In addition,

y_{d}=( [symbol] _{dn})ₙ₌₁^{N}^{_{d}}∈ [symbol] ^{N}^{_{d}} [Math. 5]

represents a set of labels for respective features of the d-th graph. y_{dn} represents a label for a feature x_{dn} of the n-th node in the d-th graph (in other words, a label for the n-th node in the d-th graph). That is, each feature x_{dn} (that is, each node of the d-th graph) corresponds to a labeled case.

Although it is assumed that graph data is provided as an example in the present embodiment, the same applies to cases where any data (for example, any vector data, image data, series data, and the like) other than graph data is provided.

It is assumed that graph data G*=(A*, X*) with an unknown label is provided at the time of testing (or at the time of operating the prediction model and the selection model, or the like). Here, the purpose of the learning apparatus 10 is to train a selection model and a prediction model that can predict labels of nodes in a provided graph with higher accuracy by assigning as few labels as possible (that is, by using the smallest possible number of nodes (cases) selected as labeling targets). Accordingly, it is assumed that the learning apparatus 10 according to the present embodiment trains a prediction model first, and then trains a selection model using the pre-trained prediction model. However, this is merely an example, and for example, the prediction model and the selection model may be simultaneously trained, or the prediction model and the selection model may be alternately trained.

Further, although it is assumed that graph data G*=(A*, X*) in which labels of all nodes in a graph are unknown is provided at the time of testing, some nodes in the graph may be labeled (that is, a small number of nodes may be labeled).

<Prediction Model and Selection Model>

For the prediction model and the selection model, any neural network can be used as long as it can receive, as an input, a feature of each node of a provided graph, an observed label, and information representing which case label is observed; integrate this information; and output the integrated information.

For example, as an input to a neural network, z_{dn}⁽⁰⁾ represented by the following formula (1) can be used.

[Math. 6]

z_{dn}⁽⁰⁾=[x_{dn}, [symbol] _{dn},m_{dn}] (1)

Here,

m_{d}∈{0,1}^{N}^{_{d}} [Math. 7]

represents a mask vector indicating which case label is observed in the d-th graph; an n-th element is m_{dn}=1 if an n-th case label is observed, and m_{dn}=0 otherwise. In the following, a case having a label observed will also be referred to as an “observed case”. That is, the mask vector m_{d} is a vector representing observed cases of the d-th graph.

In addition,

y̅_{d} [Math. 8]

represents a vector representing a label observed in the d-th graph; and if m_{dn}=1, the n-th element is

[symbol]

_{dn}= [symbol] _{dn} [Math. 9]

and otherwise

[symbol]

_{dn}=0 [Math. 10]

In the text of the description, the vector representing a label observed in the d-th graph and elements thereof are referred to as “⁻y_{d}” and “⁻y_{dn}”, respectively.

As a neural network of the prediction model and the selection model, for example, a graph convolutional neural network can be used. By using a graph convolutional neural network, information on all cases can be integrated in accordance with a graph.

The prediction model can be represented by the following formula (2), where f is a neural network.

[Math. 11]

ŷ_{d}=f(G_{d},m_{d};Φ) (2)

Here, Φ is a parameter of the neural network f.

ŷ_{d}∈ [symbol] ^{N}^{_{d}} [Math. 12]

represents a predicted value. In f in the above formula (2), Z_{dn}⁽⁰⁾ in the above formula (1) is created from G_{d} and m_{d} which have been input, and z_{dn}⁽⁰⁾ is input to the graph convolutional neural network. More accurately, f in the above formula (2) is composed of: a function for creating each z_{dn}⁽⁰⁾ from G_{d} and m_{d}; and a graph convolutional neural network having the parameter Φ.

Further, the selection model can be represented by the following formula (3), where g is a neural network.

[Math. 13]

s_{d}=g(G_{d},m_{d};Θ) (3)

Here, Θ is a parameter of the neural network g.

s_{d}=(s_{dn})ₙ₌₁^{N}^{_{d}}∈ [symbol] ^{N}^{_{d}} [Math. 14]

represents a score vector in the d-th graph, where s_{dn} represents a score with which the n-th case is selected. Similarly, in g in the above formula (3), Z_{dn}⁽⁰⁾ in the above formula (1) is created from G_{d} and m_{d} which have been input, and z_{dn}⁽⁰⁾ is input to the graph convolutional neural network. More accurately, g in the above formula (3) is composed of: a function for creating each z_{dn}⁽⁰⁾ from G_{d} and m_{d}; and a graph convolutional neural network having the parameter Θ.

<Functional Configuration>

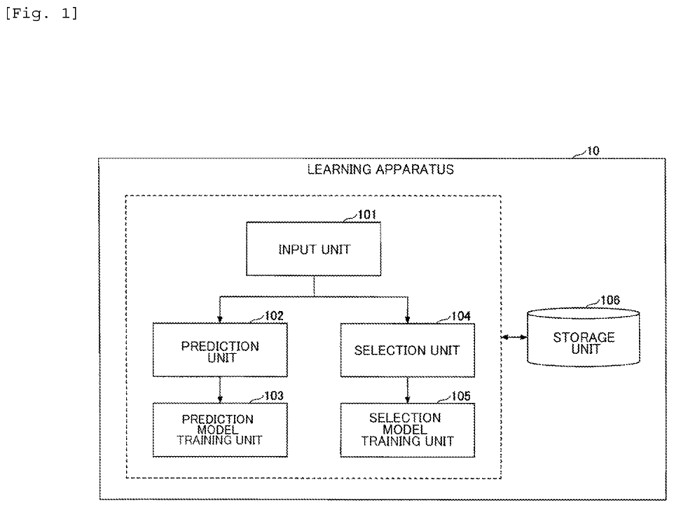

First, a functional configuration of the learning apparatus 10 according to the present embodiment will be described with reference to FIG. 1. FIG. 1 is a diagram showing an example of the functional configuration of the learning apparatus 10 according to the present embodiment.

As shown in FIG. 1, the learning apparatus 10 according to the present embodiment includes an input unit 101, a prediction unit 102, a prediction model training unit 103, a selection unit 104, a selection model training unit 105, and a storage unit 106.

The storage unit 106 stores a graph data set G, the parameters Φ and Θ that are training targets, and the like.

The input unit 101 receives the graph data set G stored in the storage unit 106 at the time of learning. The input unit 101 receives graph data G* with unknown labels at the time of testing.

Here, at the time of training a prediction model, graph data G_{d} is sampled from the graph data set G by the prediction model training unit 103, and then observed cases are sampled from a node set {1, . . . , N_{d}} of the graph data G_{d}. Similarly, at the time of training a selection model, the graph data G_{d} is sampled from the graph data set G by the selection model training unit 105, and then observed cases are sequentially sampled from the node set {1, . . . , N_{d}} of the graph data G_{d}.

The prediction unit 102 calculates a predicted value (that is, a value of a label for each node of a graph represented by the graph data G_{d}) in accordance with the above formula (2) using the graph data G_{d} sampled by the prediction model training unit 103, a mask vector m_{d} representing the observed cases sampled from the graph data G_{d}, and the parameter Φ.

At the time of testing, the prediction unit 102 calculates a predicted value (that is, a value of a label for each node of a graph represented by the graph data G*) in accordance with the above formula (2) using the graph data G*, a mask vector m* representing observed cases of the graph data G*, and parameters of the pre-trained prediction model.

The prediction model training unit 103 samples the graph data G_{d} from the graph data set G input through the input unit 101 and then samples N_{S} observed cases from the node set {1, . . . , N_{d}} of the graph data G_{d}. The number N_{S} of observed cases to be sampled is set in advance. At the time of sampling, the prediction model training unit 103 may perform the sampling randomly or may perform the sampling in accordance with a certain distribution that is set in advance.

Then, the prediction model training unit 103 updates (trains), by using errors between a label set y_{d} included in the graph data G_{d} sampled from the graph data set G and predicted values calculated by the prediction unit 102, the parameter Φ that is a training target, in such a manner that the errors decrease.

For example, the prediction model training unit 103 may update the parameter Φ that is a training target in a manner as to minimize an expected prediction error represented by the following formula (4).

[Math. 15]

[symbol]

_{G}_{_{d}}[ [symbol] [L(G_{d},m_{d};Φ)]] (4)

Here, E represents an expected value and L represents a prediction error represented by the following formula (5).

$$\begin{matrix}[ Math . 16 ] & \\ L ( {G}_{d} , {m}_{d} ; Φ ) = \frac{1}{{\sum }_{n = 1}^{{N}_{d}} ( 1 - {m}_{d n} )} {{\sum }_{n = 1}}^{{N}_{d}} ( 1 - {m}_{d n} ) {‖ {y}_{d n} - {f}_{n} ( {G}_{d} , {m}_{d} ; Φ ) ‖}^{2} & ( 5 )\end{matrix}$$

fₙ is the n-th element of f in the above formula (2) (that is, the n-th element of the predicted value).

However, any index (for example, a negative log likelihood, or the like) indicating an error of prediction may be used as a prediction error instead of L.

The selection unit 104 calculates a score vector in accordance with the above formula (3) using the graph data G_{d} sampled by the selection model training unit 105, the mask vector m_{d} representing the observed cases sampled from the graph data G_{d}, and the parameter Θ.

At the time of testing, the selection unit 104 calculates a score vector in accordance with the above formula (3) using the graph data G*, the mask vector m* representing the observed cases of the graph data G*, and parameters of the pre-trained selection model. By calculating the score vector, a node (case) can be selected as a labeling target. As a method of selecting a node that is a labeling target, for example, a node corresponding to an element having the highest value among the elements of the score vector may be selected. In addition to this, for example, a predetermined number of elements may be selected in descending order of their values from the elements of the score vector and nodes corresponding to the selected elements may be selected as labeling targets, or nodes corresponding to elements having values equal to or greater than a predetermined threshold value among the elements of the score vector may be selected as labeling targets.

The selection model training unit 105 samples the graph data G_{d} from the graph data set G input through the input unit 101 and then sequentially samples N_{A} observed cases from the node set {1, . . . , N_{d}} of the graph data G_{d}. The maximum number N_{A} of observed cases to be sampled is set in advance. Further, at the time of sampling the graph data G_{d}, the selection model training unit 105 may perform sampling randomly or may perform sampling in accordance with a certain distribution that is set in advance. On the other hand, at the time of sampling the observed cases, the selection model training unit 105 performs sampling in accordance with a selection distribution which will be described later.

The selection model training unit 105 trains the parameter Θ in such a manner that the prediction performance when a case has been selected is improved. For example, the selection model training unit 105 can use a prediction error reduction rate represented by the following formula (6) as an index of an improvement of the prediction performance.

$$\begin{matrix}[ Math . 17 ] & \\ R ( {G}_{d} , {m}_{d} , n ) = \frac{L ( {G}_{d} , {m}_{d} ; \hat{Φ} ) - L ( {G}_{d} , {m}_{d}^{( + n )} ; \hat{Φ} )}{L ( {G}_{d} , {m}_{d} ; \hat{Φ} )} & ( 6 )\end{matrix}$$

The prediction error reduction rate represented by the above formula (6) represents a prediction error reduction rate when a case is additionally selected. \hat{ }Φ (to be exact, the hat “\hat{ }” should be written directly above 0) is a pre-trained parameter of the neural network f of the prediction model. n represents a newly observed node (case) in the d-th graph, and m_{d}⁽⁺ⁿ⁾ is a mask vector m_{d} when the n-th node (case) in the d-th graph is additionally observed, that is, m_{dn′}⁽⁺⁾=1 if n′=n and m_{dn′}⁽⁺ⁿ⁾=m_{dn′} otherwise.

As an objective function at the time of training the selection model, the prediction error reduction rate represented by the above formula (6) can be used, and for example, an expected error reduction rate represented by the following formula (7) can be used.

[Math. 18]

[symbol]

_{G}_{_{d}}[ [symbol] _{(m,n)˜π(Θ)}[R(G_{d},m,n)]] (7)

That is, the parameter Θ that is a training target may be updated in such a manner that the expected error reduction rate represented by the above formula (7) is maximized. n(Θ) is a selection distribution (a distribution for selecting a node (case)) based on the selection model, and the n-th element π_{dn} of π_{d}=π_{d}(Θ) is represented by the following formula (8).

$$\begin{matrix}[ Math . 19 ] & \\ {π}_{d n} = \frac{exp ( {s}_{dn}^{′} )}{{\sum }_{m = 1}^{{N}_{d}} exp ( {s}_{dm}^{′} )} & ( 8 )\end{matrix}$$

s′_{dn}=s_{dn} when m_{dn}=0 and s′_{dn}=−∞ otherwise. As a result, cases that have already been observed are prevented from being selected.

<Flow of Training Process>

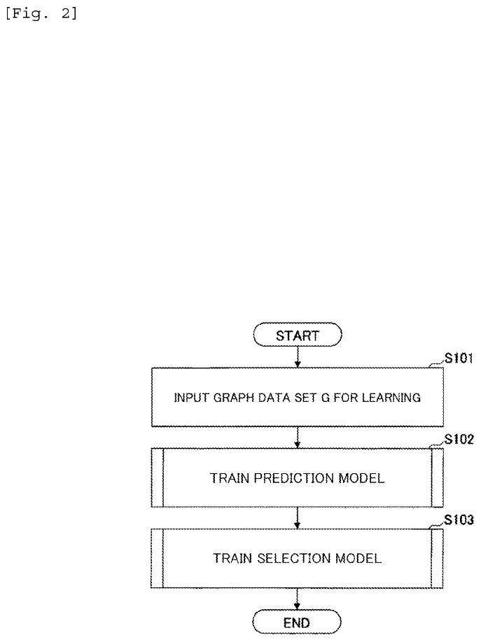

Next, a flow of training process executed by the learning apparatus 10 according to the present embodiment will be described with reference to FIG. 2. FIG. 2 is a flowchart showing an example of the flow of training process according to the present embodiment.

First, the input unit 101 receives the graph data set G stored in the storage unit 106 (step S101).

Next, the learning apparatus 10 executes a prediction model training process to train the parameter Φ of the prediction model (step S102). Subsequently, the learning apparatus 10 executes a selection model training process to train the parameter Θ of the selection model (step S103). The detailed flows of a prediction model training process and a selection model training process will be described later.

As described above, the learning apparatus 10 according to the present embodiment can train the parameter Φ of the prediction model realized by the prediction unit 102 and the parameter Θ of the selection model realized by the selection unit 104. At the time of testing, the prediction unit 102 calculates predicted values in accordance with the above formula (2) using the graph data G*, the mask vector m* representing observed cases of the graph data G*, and the pre-trained parameter \hat{ }Φ. Similarly, at the time of testing, the selection unit 104 calculates a score vector in accordance with the above formula (3) using the graph data G*, the mask vector m* representing the observed cases of the graph data G*, and the pre-trained parameter \hat{ }Θ. A value of each element of the mask vector m* is mₙ=1 if the label for the n-th node of the graph represented by the graph data G* is observed and mₙ=0 otherwise.

Further, at the time of testing, the learning apparatus 10 need not include the prediction model training unit 103 and the selection model training unit 105, and may be referred to as, for example, a “label prediction apparatus” or a “case selection apparatus”.

<<Prediction Model Training Process>>

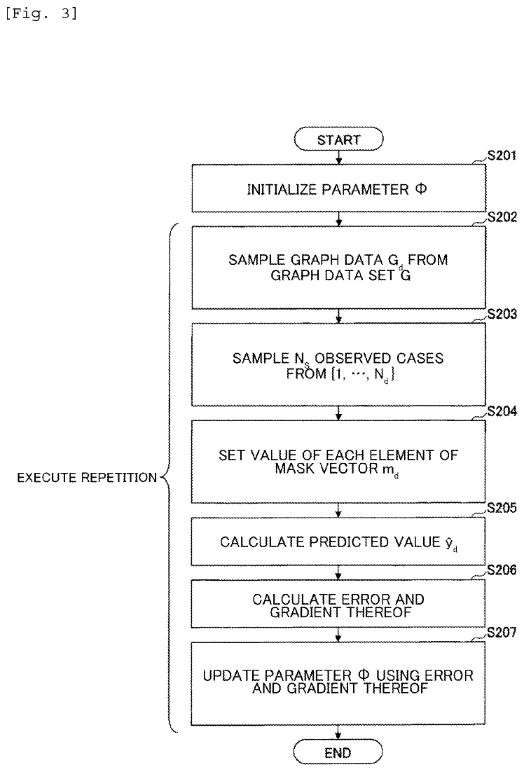

Next, a flow of prediction model training process in step S102 will be described with reference to FIG. 3. FIG. 3 is a flowchart showing an example of the flow of prediction model training process according to the present embodiment.

First, the prediction model training unit 103 initializes the parameter Φ of the prediction model (step S201). The parameter Φ may be initialized randomly or may be initialized in accordance with a certain distribution, for example.

Subsequent steps S202 to S207 are repeatedly executed until predetermined termination conditions are satisfied. The predetermined termination conditions include, for example, a condition that the parameter Φ that is a training target has converged, a condition that the repetition has been executed a predetermined number of times, or the like.

The prediction model training unit 103 samples the graph data G_{d} from the graph data set G input in step S101 of FIG. 2 (step S202).

Next, the prediction model training unit 103 samples N_{S} observed cases from the node set {1, . . . , N_{d}} of the graph data G_{d} sampled in step S202 (step S203). A set of the N_{S} observed cases will be referred to as S.

Next, the prediction model training unit 103 sets the value of each element of the mask vector m_{d} as m_{dn}=1 if n ∈S and m_{dn}=0 otherwise (step S204).

Next, the prediction unit 102 calculates a predicted value ⁻y_{d} in accordance with the above formula (2) using the graph data G_{d}, the mask vector m_{d}, and the parameter Φ (step S205).

Subsequently, the prediction model training unit 103 calculates an error L and a gradient thereof with respect to the parameter Φ in accordance with the above formula (5) using the graph data G_{d}, the mask vector m_{d}, the predicted value ⁻y_{d} calculated in step S205, and the parameter Φ (step S206). The gradient may be calculated by a known method such as an error back propagation method.

Then, the prediction model training unit 103 updates the parameter Φ that is a training target using the error L and the gradient calculated in step S206 (step S207). The prediction model training unit 103 may update the parameter Φ that is a training target in accordance with a known update formula or the like.

<<Selection Model Training Process>>

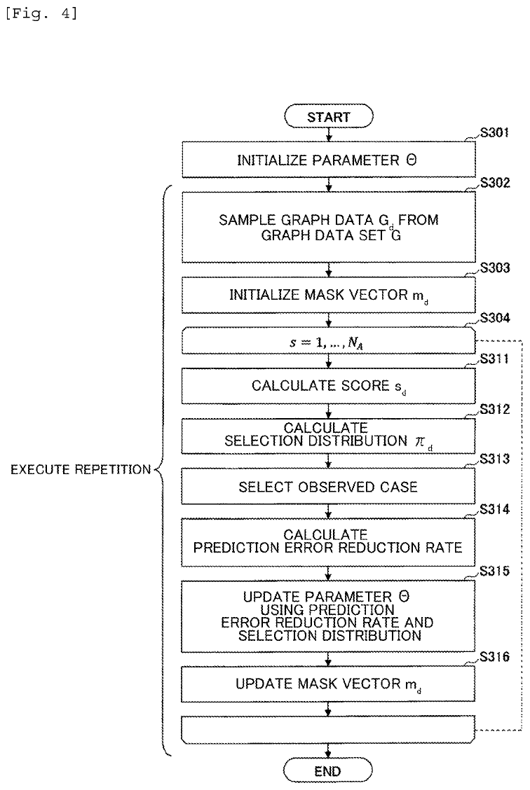

Next, a flow of selection model training process in step S103 will be described with reference to FIG. 4. FIG. 4 is a flowchart showing an example of the flow of selection model training process according to the present embodiment.

First, the selection model training unit 105 initializes the parameter Θ of the selection model (step S301). The parameter Θ may be initialized randomly or initialized in accordance with a certain distribution, for example.

Subsequent steps S302 to S304 are repeatedly executed until predetermined termination conditions are satisfied. The predetermined termination conditions include, for example, a condition that the parameter Θ that is a training target has converged, a condition that the repetition has been executed a predetermined number of times, or the like.

The selection model training unit 105 samples the graph data G_{d} from the graph data set G input in step S101 of FIG. 2 (step S302).

Next, the selection model training unit 105 initializes the mask vector m_{d} to 0 (that is, initializes the value of each element of the mask vector m_{d} to 0) (step S303)

Subsequently, the learning apparatus 10 repeatedly executes the following steps S311 to S318 for s=1, . . . , N_{A}(step S304). That is, the learning apparatus 10 repeatedly executes the following steps S311 to S318 N_{A} times. N_{A} is the maximum number of observed cases.

The selection unit 104 calculates a score vector s_{d} in accordance with the above formula (3) using the graph data G_{d}, the mask vector m_{d}, and the parameter Θ (step S311)

Next, the selection model training unit 105 calculates a selection distribution π_{d} in accordance with the above formula (8) (step S312).

Next, the selection model training unit 105 selects an observed case n from the node set {1, . . . , N_{d}} of the graph data G_{d} in accordance with the selection distribution π_{d} calculated in step S312 (step S313).

Next, the selection model training unit 105 calculates a prediction error reduction rate R (G_{d}, m_{d}, n) in accordance with the above formula (6) (step S314).

Subsequently, the selection model training unit 105 updates the parameter Θ using the prediction error reduction rate R (G_{d}, m_{d}, n) calculated in step S314 and the selection distribution n_{d} calculated in step S312 (step S315). The selection model training unit 105 may update the parameter Θ in accordance with Θ←αR (G_{d}, m_{d}, n) ∇₈ log π_{dn}, for example. α represents a training coefficient, and ∇_{Θ} represents a gradient with respect to the parameter Θ. Note that, as an example, the parameter Θ is thus updated by a policy gradient method of reinforcement learning, but the present invention is not limited thereto and the parameter Θ may be updated by another method of reinforcement learning.

Then, the selection model training unit 105 updates the mask vector m_{d} in accordance with the observed case n selected in step S313 (step S316). That is, the selection model training unit 105 updates the element m_{dn} corresponding to the observed case n selected in step S313 to 1 (that is, updates the element m_{dn} to 1).

<Evaluation Results>

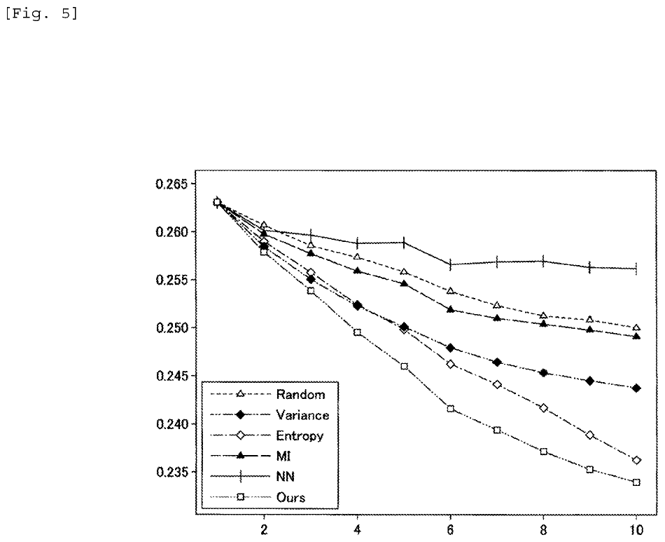

Next, evaluation results of the selection model and the prediction model trained by the learning apparatus 10 according to the present embodiment will be described. In the present embodiment, as an example, evaluation was performed using traffic data, which is one type of graph data. Results of the evaluation are shown in FIG. 5.

In FIG. 5, the horizontal axis represents the number of observed cases and the vertical axis represents a prediction error. “Random” denotes a method of randomly selecting a case, “Variance” denotes a method of selecting a case having the largest predictive variance, “Entropy” denotes a method of selecting a case having the largest entropy, and “MI” denotes a method of selecting a case having the largest mutual information. Further, “NN” denotes a case where a feed forward network is used as the selection model and the prediction model trained by the learning apparatus 10 according to the present embodiment. On the other hand, “Ours” denotes a case where a graph convolutional neural network is used as the selection model and the prediction model trained by the learning apparatus 10 according to the present embodiment.

As shown in FIG. 5, in “Ours”, a low prediction error is achieved as compared to other methods, and thus it can be seen that a high-performance prediction model has been obtained.

<Hardware Configuration>

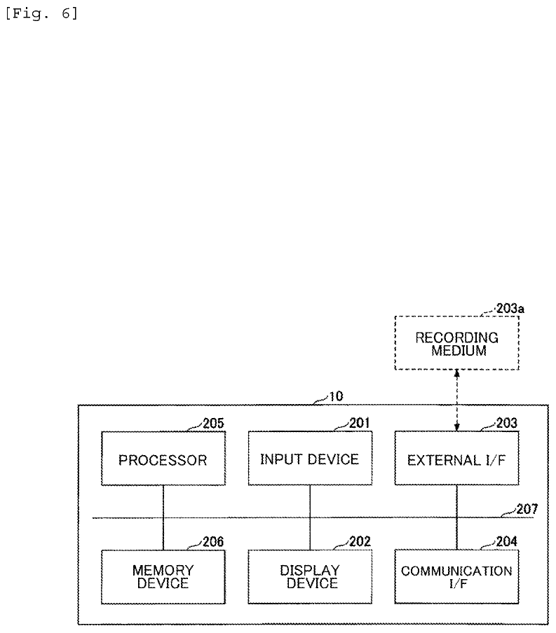

Finally, a hardware configuration of the learning apparatus 10 according to the present embodiment will be described with reference to FIG. 6. FIG. 6 is a diagram showing an example of the hardware configuration of the learning apparatus 10 according to the present embodiment.

As shown in FIG. 6, the learning apparatus 10 according to the present embodiment is realized by a general computer or computer system and includes an input device 201, a display device 202, an external I/F 203, a communication I/F 204, a processor 205, and a memory device 206. These hardware components are connected in such a manner that they can communicate with each other via a bus 207.

The input device 201 is, for example, a keyboard, a mouse, a touch panel, or the like. The display device 202 is, for example, a display or the like. The learning apparatus 10 need not include at least one of the input device 201 and the display device 202.

The external I/F 203 is an interface with an external device such as a recording medium 203a. The learning apparatus 10 can perform reading or writing of the recording medium 203a, and the like via the external I/F 203. For example, one or more programs that realize the functional units (input unit 101, prediction unit 102, prediction model training unit 103, selection unit 104, and selection model training unit 105) of the learning apparatus 10 may be stored in the recording medium 203a. The recording medium 203a may be, for example, a compact disc (CD), a digital versatile disk (DVD), a secure digital (SD) memory card, a universal serial bus (USB) memory card, or the like.

The communication I/F 204 is an interface for connecting the learning apparatus 10 to a communication network. One or more programs that realize each functional unit of the learning apparatus 10 may be acquired (downloaded) from a predetermined server device or the like via the communication I/F 204.

The processor 205 is, for example, various arithmetic operation units such as a central processing unit (CPU) and a graphics processing unit (GPU). Each functional unit included in the learning apparatus 10 is realized, for example, by processing caused by one or more programs stored in the memory device 206 to be executed by the processor 205.

The memory device 206 is, for example, any one or ones of various storage devices such as a hard disk drive (HDD), a solid state drive (SSD), a random access memory (RAM), a read only memory (ROM), and a flash memory. The storage unit 106 included in the learning apparatus 10 is realized by, for example, the memory device 206. However, the storage unit 106 may be realized by, for example, a storage device (for example, a database server or the like) connected to the learning apparatus 10 via a communication network.

The learning apparatus 10 according to the present embodiment can realize the above-mentioned training process by including the hardware configuration shown in FIG. 6. The hardware configuration shown in FIG. 6 is an example, and the learning apparatus 10 may have another hardware configuration. For example, the learning apparatus 10 may include a plurality of processors 205 or a plurality of memory devices 206.

The present invention is not limited to the above-described embodiment specifically disclosed, and various modifications and changes, combinations with known technologies, and the like are possible without departing from the description of the claims.

### REFERENCE SIGNS LIST

10 Learning apparatus
101 Input unit
102 Prediction unit
103 Prediction model training unit
104 Selection unit
105 Selection model training unit
106 Storage unit
201 Input device
202 Display device
203 External I/F
203a Recording medium
204 Communication I/F
205 Processor
206 Memory device
207 Bus

1. A learning method, executed by a computer, comprising:
receiving data G_{d} including cases and labels for the cases;
calculating a predicted value of a label for each case included in the data G_{d} using parameters of a first neural network and information representing cases in which the labels are observed among the respective cases included in the data G_{d};
selecting one case from the respective cases included in the data G_{d} using parameters of a second neural network and information representing the cases in which the labels are observed among the respective cases included in the data G_{d};
training the parameters of the first neural network using a first error between the predicted value and a value of the label for each case included in the data G_{d}; and
training the parameters of the second neural network using the first error and a second error between a predicted value of a label for each case when the one case is additionally observed and a value of the label for the case.

2. The learning method according to claim 1, wherein the training the parameters of the second neural network includes
training the parameters of the second neural network such that a reduction rate of the second error with respect to the first error is maximized.

3. The learning method according to claim 1, wherein the selecting includes
calculating a score for selecting the one case and selecting the one case in accordance with a distribution based on the score.

4. The learning method according to claim 2, wherein the selecting includes
calculating a score for selecting the one case and selecting the one case in accordance with a distribution based on the score.

5. The learning method according to claim 1, wherein the data G_{d} is data represented in a graph format where cases are indicated as nodes, and
the first neural network and the second neural network are graph convolutional neural networks.

6. The learning method according to claim 2, wherein the data G_{d} is data represented in a graph format where cases are indicated as nodes, and
the first neural network and the second neural network are graph convolutional neural networks.

7. The learning method according to claim 3, wherein the data G_{d} is data represented in a graph format where cases are indicated as nodes, and
the first neural network and the second neural network are graph convolutional neural networks.

8. The learning method according to claim 4, wherein the data G_{d} is data represented in a graph format where cases are indicated as nodes, and
the first neural network and the second neural network are graph convolutional neural networks.

9. A learning apparatus comprising a processor, the processor being configured to:
receive data G_{d} including cases and labels for the cases;
calculate a predicted value of a label for each case included in the data G_{d} using parameters of a first neural network and information representing cases in which the labels are observed among the respective cases included in the data G_{d};
select one case from the respective cases included in the data G_{d} using parameters of a second neural network and information representing the cases in which the labels are observed among the respective cases included in the data G_{d};
train the parameters of the first neural network using a first error between the predicted value and a value of the label for each case included in the data G_{d}; and
train the parameters of the second neural network using the first error and a second error between a predicted value of a label for each case when the one case is additionally observed and a value of the label for the case.

10. A non-transitory computer-readable recording medium storing a program that causes a computer to
receive data G_{d} including cases and labels for the cases;
calculate a predicted value of a label for each case included in the data G_{d} using parameters of a first neural network and information representing cases in which the labels are observed among the respective cases included in the data G_{d};
select one case from the respective cases included in the data G_{d} using parameters of a second neural network and information representing the cases in which the labels are observed among the respective cases included in the data G_{d};
train the parameters of the first neural network using a first error between the predicted value and a value of the label for each case included in the data G_{d}; and
train the parameters of the second neural network using the first error and a second error between a predicted value of a label for each case obtained when the one case is additionally observed and a value of the label for the case.
